(19) United States
(12) Patent Application Publication
(10) Pub. No.: US 2025/0254709 A1
(43) Pub. Date: Aug. 7, 2025

(54) BEAMFORMING REPORTING AND LINK ADAPTATION ENHANCEMENTS FOR NR MULTICAST SERVICE

(71) Applicant: APPLE INC., CUPERTINO, CA (US)

(72) Inventors: Pengkai ZHAO, CUPERTINO, CA (US); Haitong SUN, SARATOGA, CA (US); Yushu ZHANG, BEIJING (CN); Chunhai YAO, BEIJING (CN)

(21) Appl. No.: 18/857,454

(22) PCT Filed: Apr. 29, 2022
(86) PCT No.: PCT/CN2022/090427

§ 371 Date: Oct. 17, 2024

(51) Int. Cl. H04W 72/30; H04W 72/044; H04W 72/542

(52) U.S. Cl. CPC H04W 72/30; H04W 72/046; H04W 72/542

(57) ABSTRACT

Methods and systems are disclosed for enhancements to multicast beamforming to support PTM multicast service, concurrent multicast and unicast service, MBS, or group side-link service at the physical layer. A base station or multicast UEs of a wireless communication network may enhance reporting of the channel state information of a link between the base station and the UE and adaptation of the link for multicast beamforming. Enhancements to multicast beamforming may include techniques such as CQI table optimization and SSB-based early CQI reporting, consideration of UE preferences such as the preferred number of retransmissions and frequency-hopping preference for retransmission when designing a time-domain or frequency-domain retransmission scheme common to the multicast UEs, and multi-layer MIMO beamforming for 2-layer multicast transmissions over the horizontal and vertical polarizations and for concurrent multicast and unicast transmissions. The enhancements improve multicast service performance and efficiently allow a UE to gain access to multicast service.

### FIELD OF INVENTION

This invention relates generally to the field of wireless communication, and more particularly, to systems and methods for operating a communication network with beamforming capability when a base station of the communication network transmits to multiples wireless communication devices simultaneously in a multicast configuration. Other aspects are also described.

### BACKGROUND OF THE INVENTION

In a wireless communications network, a user equipment (UE) may communicate with a base station of the network by establishing a radio link between the UE and the base station. In the 5G (New Radio or NR) or 4G (LTE) wireless network, a UE may receive signaling and data from the serving base station in a downlink transmission direction or transmit signaling and data to the serving base station in an uplink transmission direction. The base station, UE, or both may use beamforming to improve the link budget in the downlink and uplink directions by increasing the antenna gain of the transmitting and/or receiving antenna beams. This may be particularly beneficial for higher operating bands that experience greater air-interface interference. Beamforming may also help to reduce inter-cell interference by focusing transmissions in a relatively narrow beam.

In one operating scenario, the base station may use beamforming to provide signaling and data simultaneously in time to multiple UEs by transmitting a common beam to the multiple UEs. In this operating scenario, the base station provides point-to-multipoint (PTM) multicast service at the physical layer and may be referred to as multicast beamforming. In an alternative operating scenario, the base station may generate multicast data at the application layer but may transmit different beams to the multiple UEs using a point-to-point (PTP) configuration at the physical layer to provide the multicast service. Beamforming design to support multicast beamforming may rely on the base station determining the quality of the downlink channel to each of the UEs based on the received uplink transmissions from the UEs and based on the assumption of reciprocity of the channel characteristics between the uplink and downlink directions. Alternatively, to obtain a more accurate characterization of the downlink channels to the UEs, the base station may transmit reference signals or synchronization signals on candidate beams for the UEs to estimate the quality of the downlink channels as in unicast beamforming. The UEs may measure and report back to the base station the downlink channel quality estimated from the received reference or synchronization signals for the base station to design the beam for use in multicast beamforming. Design of multicast beamforming has unique design challenges because the common beam is transmitted to the multiple UEs. The base station may balance different capabilities of the UEs and different downlink channel characteristics to the UEs to design the beam. It is desired to enhance the design of beamforming to more efficiently and effectively support UEs operating in the multicast configuration.

### SUMMARY OF THE DESCRIPTION

Methods and systems are disclosed for a UE to support a base station of a wireless network transmitting in a multicast beamforming configuration. In a network providing multicast service, the network may maintain a control policy for admission by granting a UE access to the multicast service based on the channel characteristics measured by the UE. For example, a base station of the 4G/5G network may transmit channel state information reference signals (CSI-RS) over physical resources reserved for multicast service. The base station may transmit the CSI-RS using one or more multicast beams. A UE wishing to join the multicast service may measure channel characteristics of the downlink channel based on the received multicast CSI-RS and may report the measurements back to the base station. The base station may admit or reject the UE for multicast service based on the reported measurements. The base station may also transmit synchronization signal block (SSB) signals over synchronization signal/physical broadcast channel (SS/PBCH) by the UE during cell search procedures and also during beam management procedures. The UE may measure channel state information of the downlink channel based on the SSB signals and may report the best downlink beam(s) during beam management procedures. The reporting of the channel state information allows rapid and responsive beamforming and switching between beams. The measurements are affected by downlink beamforming designs including the downlink transmit beam from the base station and the UE's downlink receive beam. Disclosed are techniques for the UE and the base station to enhance UE reporting of the channel state information of the downlink and adaptation of the link for multicast beamforming used to provide multicast PTM or concurrent multicast and unicast service. The disclosed techniques may also be applicable to 5G beamforming multicast and broadcast service (MBS) or 5G beamforming side-link group-cast service.

In one aspect, the technique may include simplifying the measurements of channel characteristics reported as channel quality indicator (CQI) by the UE. The CQI may represent the signal to interference plus noise ratio (SINR) calculated as a ratio of the target signal measured using the CSI-RS carried by the multicast beam and interference level measured when there is no transmission on the physical resources reserved for the multicast service. In unicast beamforming when measuring channel characteristics, CQI may be reported for a range of modulation and coding schemes (MCS). Because multicast usually focuses on a limited number of MCS configurations to ensure reliable transmission to the multiple UEs, the base station may reduce the feedback overhead by limiting the number of MCS configurations for CQI measurement and reporting. In one aspect, the base station may configure multiple multicast beam candidates for the UE to measure and report the CQI of each beam candidate.

In one aspect, the techniques may include the UE measuring the CQI based on synchronization signal block (SSB) signals and reporting SSB-based CQI at the beginning of radio resource control (RRC) connection setup. For downlink beam management, the base station may transmit SSB signals using a less spectrum-efficient MCS carried on relatively wide beams for initial acquisition by the UE. The base station may then transmit CSI-RS carried on more directional beams for beam refinement. Because multicast transmission usually uses reliable MCS and may not need fine-grained CQI reporting based on the CSI-RS, the CQI derived from the SSB signals may be sufficient to indicate the downlink channel quality. The UE may report SSB-based CQI early during the RRC connection setup during the random access process, during the handover process from one base station to another base station, or when transitioning from the RRC inactive state to the RRC connected state.

In one aspect, the UE may report the desired number of multicast retransmissions when reporting channel characteristics. To support multicast retransmission when a multicast transmission fails to be received by any one of the multicast UEs, the number of retransmissions may be the same for all the multicast UEs. To facilitate network decision, the UEs may report the desired multicast retransmission number for the network or the base station to determine the final retransmission number based on the feedback. In one aspect, the base station may configure multiple multicast beam candidates for measurement and the UE may report or maintain different retransmission numbers for different beam candidates. In one aspect, the multicast retransmission may be implemented in the frequency domain using different frequency sub-bands such as through frequency hopping. In one aspect, the UE may report its desired multicast retransmission number for multicast service when the UE is in the RRC inactive state.

In one aspect, the base station may transmit the multicast beams in more than one layer using multi-layer beamforming. For example, the base station may transmit multicast service in two layers over the horizontal polarization and vertical polarization to increase the transmission rate. In another example, the base station may use multi-layer multiple-input multiple-output (MIMO)/beamforming for concurrent multicast and unicast transmission. The multicast data may be mapped to a first subset of one or more layers and the unicast data mapped to a second subset of one or more layers of the multiple layers. The base station may transmit the multicast data and the unicast data simultaneously using different downlink transmission beams.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one aspect of the disclosure.

FIG. 2 illustrates user equipment in direct communication with a base station (BS) according to one aspect of the disclosure.

FIG. 3 illustrates an example block diagram of a UE according to one aspect of the disclosure.

FIG. 4 illustrates an example block diagram of a BS according to one aspect of the disclosure.

FIG. 5 illustrates an example block diagram of cellular communication circuitry according to one aspect of the disclosure.

FIG. 6 illustrates a scenario for a base station of a wireless communication network to control admission of a UE to receive multicast service based on the UE measuring and reporting to the base station channel characteristics of downlink channels, according to one aspect of the disclosure.

FIG. 7 illustrates a flow diagram of signaling between the base station and the UE for the UE to gain admission to multicast resources based on the UE reporting measured channel quality of channel state information reference signals (CSI-RS) transmitted by the base station, according to one aspect of the disclosure.

FIG. 8 illustrates a channel quality indicator (CQI) table for a subset of a range of modulation and coding schemes (MCS) measured and reported by the UE to reduce the overhead associated with reporting channel quality of received CSI-RS, according to one aspect of the disclosure.

FIG. 9 illustrates a flow diagram of signaling between the base station and the UE for the UE to measure CQI based on synchronization signal block (SSB) signals and to report SSB-based CQI using the contention-based random access channel (RACH) process to allow early reporting of channel characteristics during the radio resource control (RRC) connection setup, according to one aspect of the disclosure.

FIG. 10 illustrates a flow diagram of signaling between the base station and the UE for the UE to measure CQI based on SSB signals and to report SSB-based CQI using the 2-step RACH process to allow early reporting of channel characteristics during the RRC connection setup, according to one aspect of the disclosure.

FIG. 11 depicts a flow diagram of a method for a UE to measure and report channel quality of a downlink beam to enable a base station to adapt the downlink beam as a multicast beam to provide multicast service to the UE and other UEs of a multicast group, according to one aspect of the disclosure.

### DETAILED DESCRIPTION

Methods and systems are disclosed for enhancements to multicast beamforming to support PTM multicast service, concurrent multicast and unicast service, MBS, or group side-link service at the physical layer. A base station or multicast UEs of a wireless communication network may apply the disclosed techniques to enhance reporting of the channel state information of a link between the base station and the UE and adaptation of the link for multicast beamforming to support the provisioning of service in PTM multicast, concurrent multicast and unicast, MBS, or group side-link configurations. The enhancements improve multicast service performance and efficiently allow a UE to gain access to multicast service. Multicast beamforming may also be applied to MIMO beamforming to increase diversity gain, array gain, or spatial multiplexing gain. Aspects of the enhancements are explained in the context of 4G LTE and 5G NR networks, but may be applied to other networks such as Wi-Fi, etc.

Enhancements to multicast beamforming may include techniques such as CQI table optimization and SSB-based early CQI reporting, consideration of UE preferences such as the preferred number of retransmissions and frequency-hopping preference for retransmission when designing a time-domain or frequency-domain retransmission scheme common to the multicast UEs, and multi-layer MIMO beamforming for 2-layer multicast transmissions over the horizontal and vertical polarizations and for concurrent multicast and unicast transmissions.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

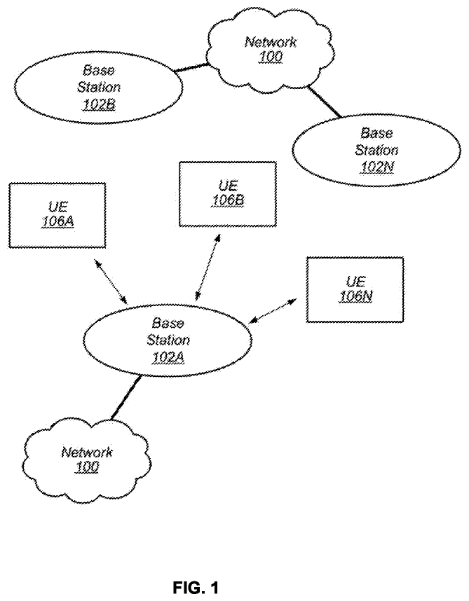

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5GNR, HSPA, 3GPP2 CDMA2000 (e.g., 1×RTT, 1×EV-DO, HRPD, eHIRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

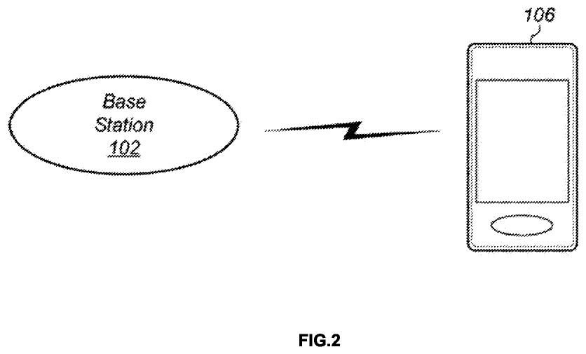

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

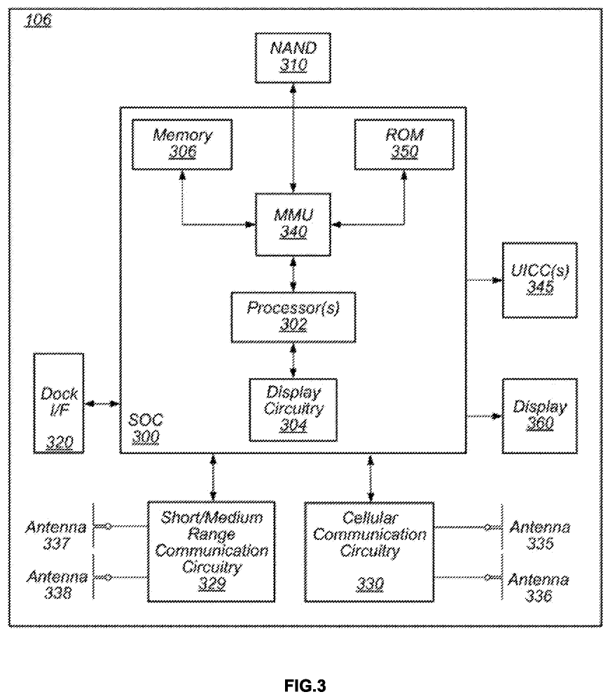

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

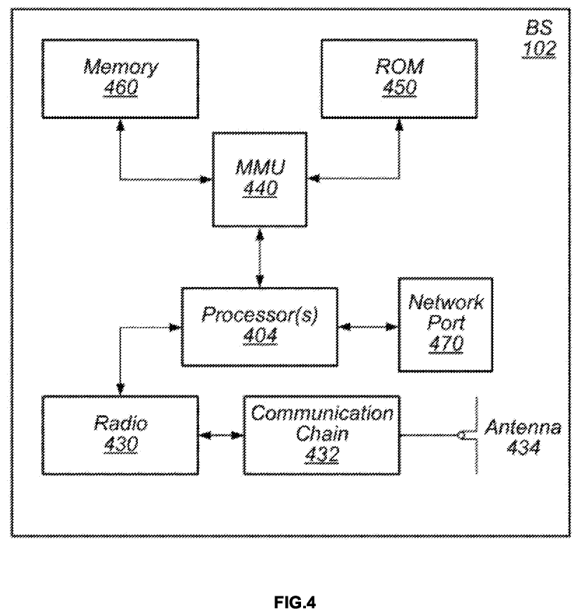

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

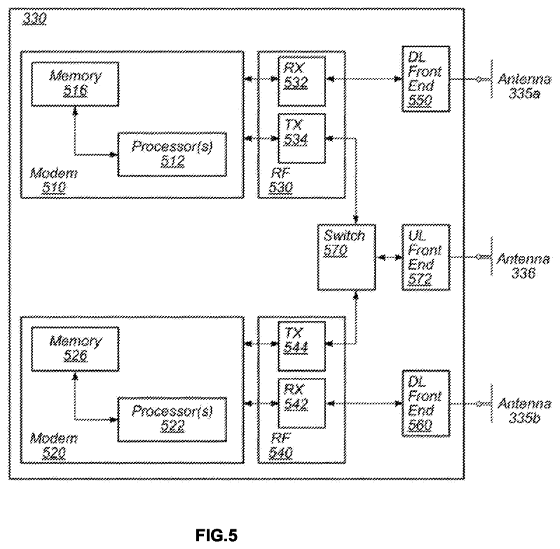

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

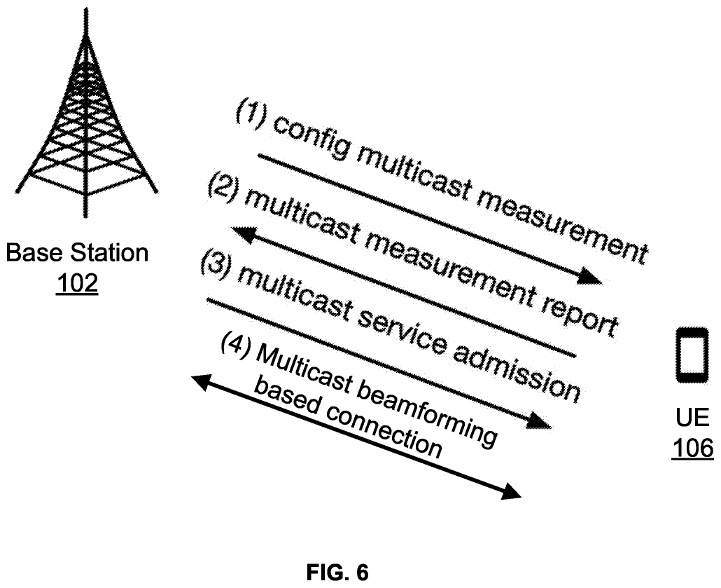

FIG. 6 illustrates a scenario for a base station 102 of a wireless communication network to control admission of a UE 106 to receive multicast service based on the UE measuring and reporting to the base station channel characteristics of downlink channels reserved for multicast service, according to one aspect of the disclosure. In the following description, the terms “base station” and “network” may be used interchangeably.

The base station 102 maintains a control policy for admission, where UEs are granted multicast service based on their measured channel quality. For example, the base station 102 may transmit channel state information reference signals (CSI-RS) over physical resource reserved for multicast service, where such CSI-RS may also be referred to as multicast CSI-RS. In one aspect, if the multicast transmission uses only 1-layer transmission, the multicast CSI-RS may be simply transmitted using 1-port. In one aspect, the base station 102 may transmit the multicast CSI-RS using one or more multicast beams. The base station 102 may transmit information to inform UEs of the physical resources used to transmit the CSI-RS and the configuration for reporting the measured channel characteristics.

A UE 106 wishing to join the multicast service may measure channel characteristics of the downlink channel based on the received multicast CSI-RS and may report the measurements back to the base station. In one aspect, the UE 106 may estimate channel characteristics using metrics such as channel quality indicator (CQI) and/or precoding matrix indicator (PMI) from the multicast CSI-RS. The CQI may represent the signal to interference plus noise ratio (SINR) calculated as a ratio of the target signal measured using the CSI-RS carried by the multicast beam and interference level measured when there is no transmission on the physical resources reserved for the multicast service. The PMI may allow the UE 106 to recommend a precoding matrix for the downlink multicast transmission in a closed loop beamforming scheme. The UE 106 may report the estimated CQI/PMI back to the base station 102. The CQI/PMI measurements are affected by downlink beamforming designs including the downlink multicast transmit beam from the base station 102 and the UE's (106) downlink receive beam. Using the CQI/PMI report, the network or the base station 102 may admit or reject the UE 106 for multicast service. The base station 102 may determine the multicast beam based on the measurement reports from the UEs admitted into the multicast group. The admitted UE 106 may then receive multicast service based on the connection established by the multicast beam.

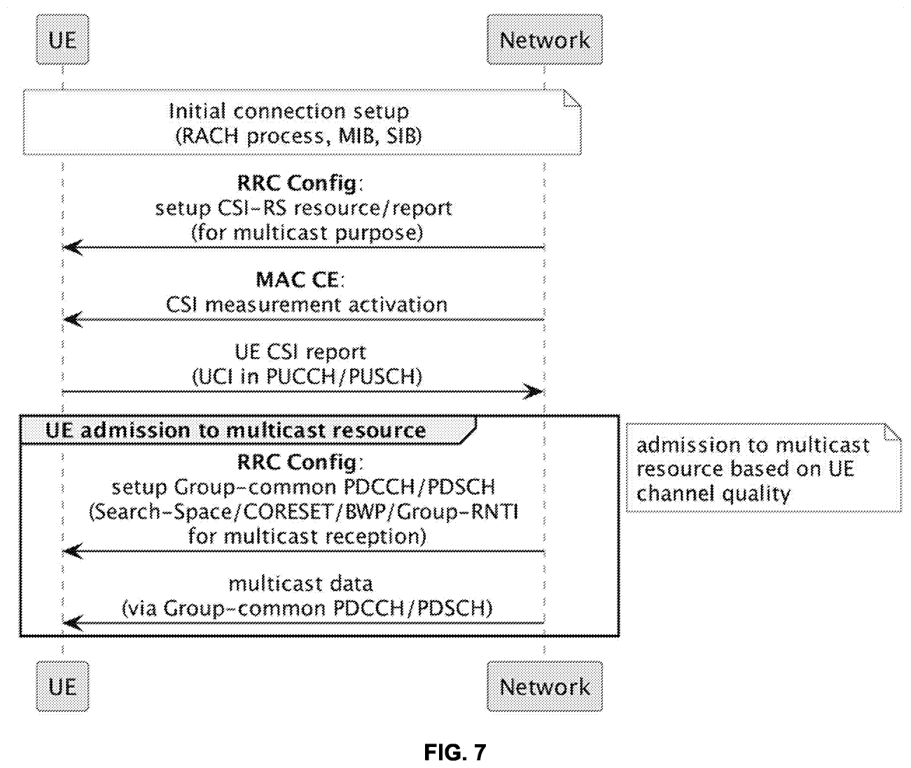

FIG. 7 illustrates a flow diagram of signaling between the base station of a 4G or 5G wireless network and a UE for the UE to gain admission to multicast resources based on the UE reporting measured channel quality of CSI-RS transmitted by the base station, according to one aspect of the disclosure.

The network may configure the UE for initial connection setup including resource configuration for the random access channel (RACH) process and system information such as master information block (MIB) and system information block (SIB) for the UE to access the network. When the UE accesses the network, the network may transmit radio resource control (RRC) messages to the UE to setup CSI-RS physical resources used by the base station to transmit the multicast CSI-RS and the reporting configuration used by the UE to report the measured channel quality based on the multicast CSI-RS. The network may transmit medium access control (MAC) control element (CE) on the physical downlink shared channel (PDSCH) to activate the CSI-RS measurement by the UE.

The UE wishing to receive multicast service may measure channel characteristics such as CQI/PMI of the multicast CSI-RS and may report the measurement as uplink control information (UCI) as part of the channel state information (CSI) reporting carried on the physical uplink control channel (PUCCH) or the physical uplink shared channel (PUSCH). The measurements are affected by multicast downlink (DL) beamforming design including the base station's multicast DL transmit beam and the UE's DL receive beamforming. The network may perform multicast beamforming and beam management based on the measurements reported by UEs already admitted into the multicast group and UEs wishing to join the multicast group.

The network may grant admission to the UE to receive multicast resources based on the measured channel characteristics reported by the UE. In one aspect, the network may transmit to the UE RRC configuration message containing multicast group-common signaling to the admitted UE to setup the physical downlink control channel (PDCCH) or the PDSCH for the UE to receive multicast service. In one aspect, the multicast group-common signaling may include search-space, control resource set (CORESET), bandwidth part (BWP), and group-common radio network temporary identifier (RNTI) for multicast reception. The UE may then receive multicast data via the multicast group-common PDCCH or PDSCH.

The network may simplify the measurements of channel characteristics reported as CQI by the UE. In beamforming associated with the provisioning of unicast service, a unicast UE may report CQI for a range of modulation and coding schemes (MCS). For example, NR has 3 existing CQI tables corresponding to the set of MCS tables for PDSCH: a 64QAM table with a block error rate (BLER) of 0.1 when 256QAM is not supported by the base station or UE, a 256QAM table with a BLER of 0.1 when 256QAM is allocated, and a low spectral efficiency table with a FLER of 1e-5 for applications that require lower coding rate for reliable data transfer. The CQI values may be signaled using 4 bits. High CQI values indicate that the UE is able to receive high order modulation with a high coding rate. Because multicast service usually focuses on a limited number of MCS configurations to ensure reliable transmission to the multicast UEs, the network may reduce the feedback overhead by limiting the number of MCS configurations for CQI measurement and reporting.

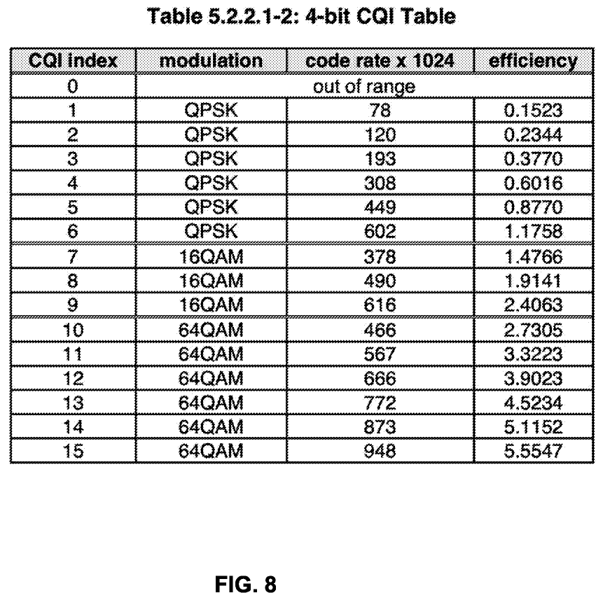

FIG. 8 illustrates the CQI table for 64QAM in which the CQI corresponding a subset of the MCS may be measured and reported by the UE to reduce the overhead associated with reporting channel quality of received multicast CSI-RS, according to one aspect of the disclosure. In FIG. 8, the efficiency figures provide a measure of the spectral efficiency (SE) associated with the MCS configurations given by the modulation order multiplied by the coding rate.

In one aspect, the network may reduce the reporting of CQI table by increasing the step size of the SE. This is because the provisioning of multicast service usually focuses on a few limited MCS configurations. As a result, multicast may be interested in only a subset of the MCS configurations from existing CQI tables. For example, the network may define a subset CQI table for multicast beamforming from the existing 64QAM CQI table to reduce the number of bits for reporting. The subset CQI table may be selected by using a larger step-size in SE. In one aspect, the network may use a bit-mask to indicate which subset from the existing CQI table to be used by the UE for reporting multicast channel quality. In one extreme example, the network may configure bitmask to let the UE only report either CQI index 1 (QPSK) with a SE of 0.1523 or CQI index 7 (16QAM) with a SE of 1.4766. The UE may only need 1 bit for reporting since only 2 MCS configurations are used.

In one aspect, the network may reduce the feedback overhead by using a 1-bit feedback report for the multicast service. For example, the network may configure a given threshold for reporting purpose (e.g., it may be a pre-defined spectral-efficiency requirement). The UE may use the 1-bit feedback to indicate whether it can meet this given threshold (value 1), or if it fails to meet it (value 0).

In one aspect, the network may use 2-bit differential feedback for the multicast service. Instead of configuring a pre-defined threshold for reporting purpose, the network may set up a multicast transmission with a current MCS configuration. The UE may report whether it prefers better or worse MCS configuration compared to the current one. For example, the UE may use 2-bit to indicate the one of the following options: (1) the UE can support better MCS configuration than the current multicast MCS configuration; (2) the UE is satisfied with the current multicast MCS configuration so there is no need for adjustment; or (3) the UE can only support worse MCS configuration than the current multicast MCS configuration.

In one aspect, the UE may provide an early CQI report at the beginning of radio resource control (RRC) connection setup. For downlink beamforming and beam management, the base station may transmit SSB signals using a less spectrum-efficient MCS carried on relatively wide beams for initial acquisition by the UE. The base station may transmit CSI-RS carried on more directional beams for beam refinement. Given that multicast service mostly uses reliable MCS and 1-layer transmission, it is possible to derive an early CQI using the SSB signal, and for the UE to quickly report such SSB-based CQI (e.g., through the RACH process). For example, multicast beamforming may not need fine-grained CQI report provided by the CSI-RS measurements since multicast service mostly uses reliable MCS configurations. Thus, CQI derived from SSB may be sufficient for indication of channel quality for multicast beamforming.

Another advantage for early SSB-based CQI reporting is that multicast transmission usually targets a number of UEs. Before a new UE wishing to join the multicast group can establish the RRC connection, multicast transmission probably already exists (due to other concurrent serving UEs). Thus, the network may reduce the latency of the new UE accessing existing multicast resources by configuring the UE for early and fast SSB-based CQI reporting. Early CQI report during the RACH procedure may also improve the robustness of the RACH procedure and the reliability of further communication between the UE and base station.

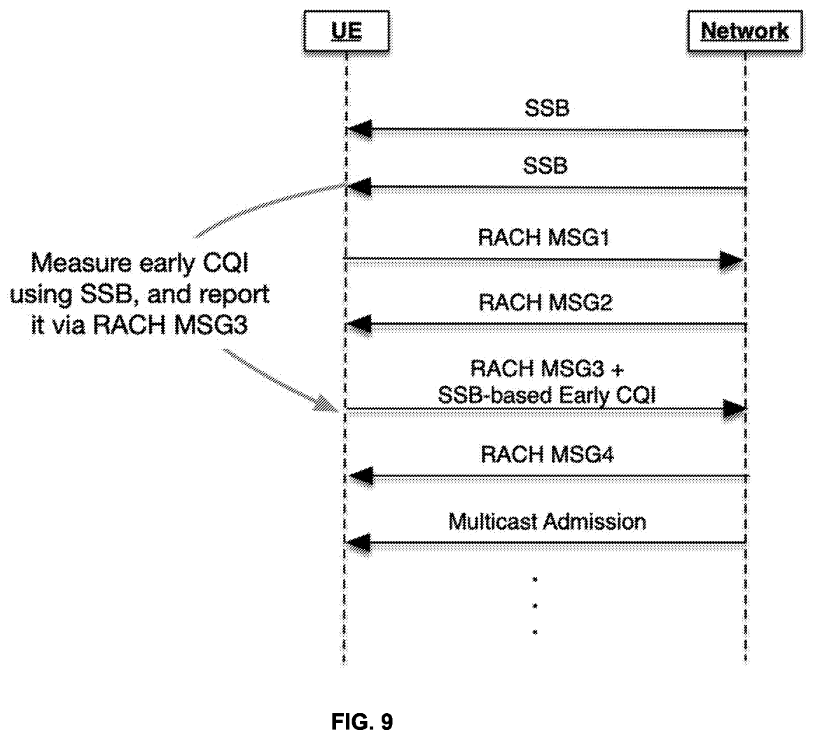

FIG. 9 illustrates a flow diagram of signaling between the base station and the UE for the UE to measure CQI based on SSB signals and to report SSB-based CQI using the contention-based RACH process to allow early reporting of channel characteristics during the RRC connection setup, according to one aspect of the disclosure.

In one aspect, during a RRC connection setup such as when going from RRC_IDLE to RRC_CONNECTED, the UE may measure and report the multicast CQI based on the SSB signals. During the contention-based RACH process, the UE may select a random access preamble from a pool of preambles shared with other UEs. The UE may transmit the selected random access preamble to the network on message 1 (MSG1). The network may transmit the random access response (RAR) on message 2 (MSG2) in response to the detection of MSG1 transmitted by the UE for further contention resolution. The RAR may provide the uplink resource allocation to schedule the transmission of message 3 (MSG3) from the UE.

The base station may transmit a number of SSB signals. Each SSB may be transmitted with different beam in order to provide ubiquitous and robust coverage. Each SSB signal may be associated with its corresponding RACH occasion. The UE will try to detect and measure the quality of SSB signals. To reduce latency, the UE may not finish the measurement of all SSB signals before deciding which RACH occasion the UE may use for MSG1. As long as the SSB quality meets the performance requirement, UE may use the RACH occasion corresponding to that SSB signal for MSG1, and the further communication with the network may be based on the beam of that SSB signal until the UE can report the best beam. The network may then reconfigure the beam used for communication after RRC connection setup. Consequently, to reduce RACH latency, the UE may try to establish the RRC connection with the network on the RACH occasion corresponding to the first SSB signal that meets the performance requirement and continue the RACH procedure based on the first SSB beam. If the UE finds a better SSB signal, the UE may report the better SSB-based CQI to the network using message 3 of the RACH process.

The network may complete contention resolution by transmitting message 4 (MSG4) to the UE for the UE to determine that it has successfully completed the RACH process. The network may grant admission to the UE to receive multicast resources based on the SSB-based CQI reported by the UE. The network may then transmit to the UE RRC configuration message containing multicast group-common signaling to setup the PDCCH or the PDSCH for the UE to receive the multicast service. Advantageously, early SSB-based CQI reporting allows the UE to update the network with the best beam as early as MSG3 during the RACH procedure. It also allows the UE to update the network with the latest channel if there is significant latency between MSG1 and MSG3.

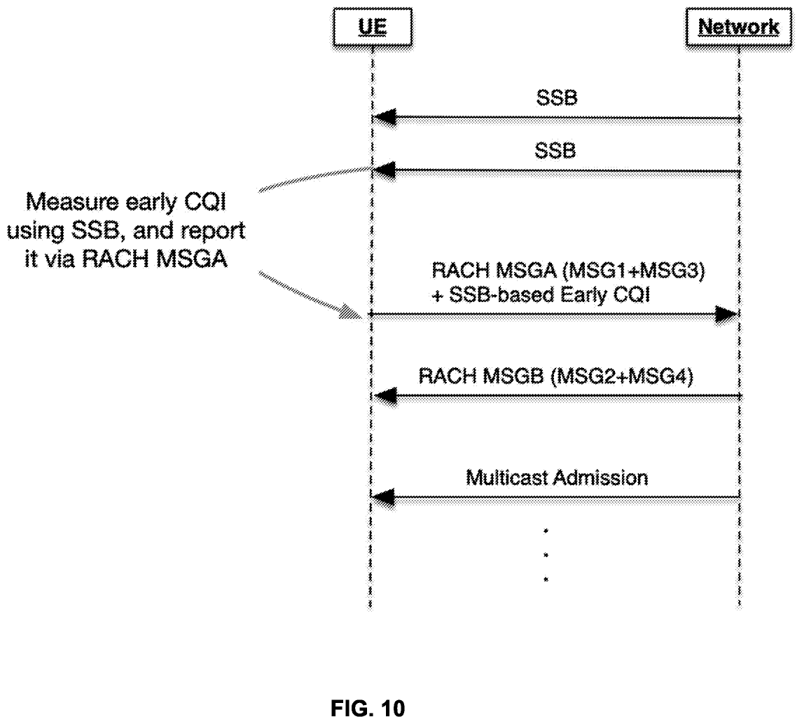

FIG. 10 illustrates a flow diagram of signaling between the base station and the UE for the UE to measure CQI based on SSB signals and to report SSB-based CQI using the 2-step RACH process to allow early reporting of channel characteristics during the RRC connection setup, according to one aspect of the disclosure.

In the 2-step RACH process, the UE can transmit random access preamble and PUSCH payload together in one round. The UE may measure the multicast CQI based on the SSB signals and report SSB-based CQI to the network as part of message A (MSGA) used to include both random access preamble and PUSCH payload. In one aspect, the UE may measure the multicast CQI when the UE determines whether the SSB signals of the beam providing the dedicated random access preamble has sufficient strength. The network may transmit the random access response to the UE on message B (MSGB) to indicate the completion of the RACH process. As in the contention-based RACH process, the network may grant admission to the UE to receive multicast resources based on the SSB-based CQI reported by the UE. The network may then transmit to the UE RRC configuration message containing multicast group-common signaling to setup the PDCCH or the PDSCH for the UE to receive the multicast service.

In one aspect, the RACH process associated with a handover procedure may similarly use early SSB-based CQI reporting. For example, the UE may report the SSB-based CQI to the network using MSG3 during a handover procedure using the contention-based RACH process or using MSGA during a handover procedure using the 2-step RACH process.

In one aspect, during a RRC connection setup such as when going from RRC_INACTIVE to RRC_CONNECTED, the UE may report the multicast CQI based on the SSB signals. For example, when the UE is in RRC_INACTIVE, the network may configure the UE to track and measure multicast CQI based on the SSB signals. When the UE transitions from RRC_INACTIVE to RRC_CONNECTED, the UE may report the SSB-based CQI. In one aspect, when the UE triggers re-selection of a new cell during RRC_INACTIVE, the UE may attach the SSB-based CQI report in the RACH process toward the re-selected new cell.

In one aspect, retransmission strategy may be enhanced to support retransmission of previously transmitted PCSCH for multicast service. It is likely that more than 1 UE of the multicast group may require retransmission since different UE experience different channel conditions. It will be very inefficient to either (1) schedule MBS retransmission to all UEs even though some UEs may already successfully decode the PDSCH, or (2) independently schedule multiple unicast PDSCH to each MBS UE that requires retransmission. Retransmission enhancements may help to reduce the retransmission overhead and improve diversity during retransmission.

To support multicast retransmission when a multicast transmission fails to be received by any one of the multicast UEs, the number of retransmissions may be the same for all the multicast UEs. To facilitate network decision, each UE may report the desired multicast retransmission number for the network or the base station to determine the final retransmission number based on the feedback from the UEs. In one aspect, the base station may configure multiple multicast beam candidates for measurements. The UE may measure the quality of each multicast beam candidate, as well as the preferred retransmission number for each beam candidate. The UE may maintain different preferred retransmission numbers for different beam candidates and may choose which one to report later.

Multicast retransmission may use the same frequency band. In one aspect, the multicast retransmission may be implemented using different frequency sub-bands such as through frequency hopping. As part of UE beam report, the UE may also indicate whether frequency-hopping is preferred for multicast retransmission for a beam candidate.

In one aspect, the UE may report its preferred number of retransmission for multicast service in RRC_INACTIVE state. For example, before transitioning from RRC_CONNECTED to RRC_INACTIVE, UE (under RRC_CONNECTED state) may report its preferred retransmission number for RRC_INACTIVE. Later, network may apply UE's feedback during RRC_INACTIVE state.

In one aspect, the UE-preference information may be reported to the network via RRC signaling “UEAssistanceInformation,” which is used by a UE to report its various preference information. For multicast beamforming, a new element may be defined within “UEAssistanceInformation.” One example of the new element may be:

| | |
|---|---|
| Multicast-Assistance::= | SEQUENCE { |
| preferredNumRetx | INTEGER (0..3), |
| freqHopPreferred | ENUMERATED {true} OPTIONAL, |
| preferredNumInactRetx | INTEGER (0..3), |
| } | |

where “preferredNumRetx” indicates the preferred number of retransmission in multicast; “freqHopPreferred” indicates whether frequency-hopping is preferred for multicast retransmission; and “preferredNumInactRetx” indicates the preferred number of retransmission number in RRC_INACTIVE state. A new element may be defined for each beam candidate.

In one aspect, the base station may transmit the multicast beams in more than one layer using multi-layer beamforming. For example, in NR, UE may support maximum 4 PDSCH layers for NR bands above 2.5 GHz in FR1 and maximum 2 PDSCH layers for the other cases. PDSCH transmission with higher number of layers can utilize the spectrum more efficiently and reduce the communication latency as well as improve the communication reliability. For multicast service, MIMO layer adaptation enhancements for MBS may allow the network to select the maximum number of layers that can be served among all multicast UEs. MIMO layer adaption enhancements to support multicast service may include (1) enhancement on UE capability reporting and (2) enhancement on UE RI/PMI/CQI reporting.

For example, in FR2, the base station may transmit multicast service in two layers over the horizontal polarization and the vertical polarization to increase the transmission rate. In another example, the base station may use multi-layer MIMO/beamforming for concurrent multicast and unicast transmission. Concurrent multicast and unicast transmissions may be from the same base station or from different base stations, such as in a multi-transmission/reception point (multi-TRP) scenario. The UE may receive multicast and unicast PDSCH concurrently in time carried on different beams or on the same beam. The UE may use the same hardware resource to receive the multicast and unicast PDSCH, which may be transmitted using frequency range 2 (FR2 of 24.25 GHz to 52.60 GHz). The multicast data may be mapped to a first layer and the unicast data mapped to a second layer. The base station may transmit the multicast data and the unicast data simultaneously using different downlink transmission beams.

In one aspect, the UE may support up to X layers, where at most X_M layers are used for multicast transmission and at most X_U layers are used for unicast transmission concurrently in time (X_M+X_U=X). The multicast and unicast transmissions may be from two base-station/TRPs, and each layer may be associated with one DL Tx beam. To support above features, the UE may indicate its capability in RRC capability report. Legacy RRC signaling for UE capability has an element “FeatureSetDownlink” that may be modified to indicate the number of multicast layers and unicast layers supported by the UE.

In one aspect, the UE may report its capability information for supporting multi-layer beamforming to the network via legacy RRC signaling “FeatureSetDownlink,” which is used by a UE to report its capability. A new element may be defined within “FeatureSetDownlink” to indicate the number of multicast layers and unicast layers supported by the UE. One example of the new element may be:

FeatureSetDownlink ::= SEQUENCE {
......
multicastJointMIMO ENUMERATED {2M0U, 1M1U, 2M2U} OPTIONAL,
......
}

where 2M0U indicates 2 multicast layers with no support for concurrent unicast layer; 1M1U indicates 1 multicast layer and 1 unicast layer may be concurrently supported in time; and 2M2U indicates 2 multicast layers and 2 uncast layers may be concurrently supported in time. In one aspect, “FeatureSetDownlink” may be fined separately for each band to cover both two-layer multicast transmission using the horizontal/vertical polarizations and the concurrent multicast/unicast transmission.

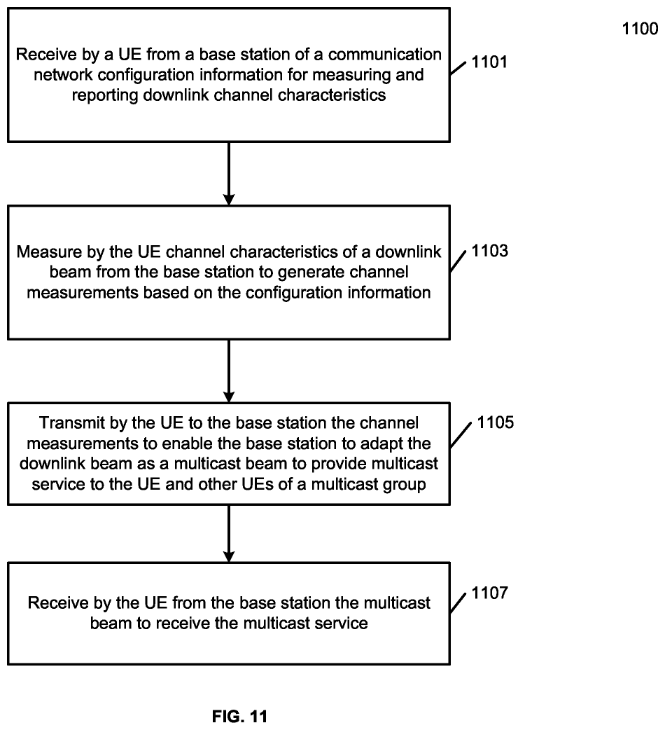

FIG. 11 depicts a flow diagram of a method 1100 for a UE to measure and report channel quality of a downlink beam to enable a base station to adapt the downlink beam as a multicast beam to provide multicast service to the UE and other UEs of a multicast group, according to one aspect of the disclosure. The method may be practiced by the UE of FIGS. 1, 2, 3, 5, 6, 7, 9, and 10.

In operation 1101, the UE receives configuration information from the base station for measuring and reporting downlink channel characteristics.

In operation 1103, the UE measures channel characteristics of a downlink beam from the base station to generate channel measurements based on the configuration information.

In operation 1105, the UE transmits the channel measurements to the base station to enable the base station to adapt the downlink beam as a multicast beam to provide multicast service to the UE and other UEs of a multicast group.

In operation 1107, the UE receives the multicast beam to receive the multicast service.

In one aspect, the described operations to enhance reporting of the channel state information of links used for multicast downlink transmissions and adaptation of the links for multicast beamforming may be practiced by a UE that includes at least one antenna, at least one radio, and at least one processor. The radio may be configured to communicate with a communication network (e.g., a base station) through the antenna. The processor may be coupled to the radio and configured to perform the described operations. The operations may include the UE receiving from the communication network configuration information for measuring and reporting downlink channel characteristics. The operations may also include the UE measuring channel characteristics of a downlink beam from the communication network to generate channel measurements based on the configuration information. The operations may further include the UE reporting the channel measurements to the communication network to enable the communication network to adapt the downlink beam as a multicast beam to provide multicast service to the UE and other UEs of a multicast group. The UE may then receive the multicast beam from the communication network to receive the multicast service.

In one aspect, the configuration information may include information for the UE to measure the channel characteristics of the downlink beam based on reference signals transmitted using a reduced subset of MCS configurations compared to the MCS configurations of reference signals used for measuring channel characteristics of a unicast downlink beam.

In one aspect, the configuration information may include a channel quality threshold. The channel measurements reported to the communication network may include an indication of whether the channel characteristics of the downlink beam measured by the UE meet the channel quality threshold.

In one aspect, the configuration information may include a current MCS configuration of the downlink beam. The channel measurements reported to the communication network may include an indication of whether the UE can support a MCS configuration having higher, equal, or lower spectrum efficiency compared to the current MCS configuration.

In one aspect, the configuration information may include information for the UE to measure the channel characteristics of the downlink beam based on synchronization signals (SSB) transmitted by the communication network. The UE may measure the synchronization signals, which are used by the UE to establish a connection to the communication network, for early reporting of the channel quality of the downlink.

In one aspect, the UE may report a preferred multicast retransmission number that may be used by the communication network to retransmit a previously transmitted multicast payload that fails to be received by the UE.

In one aspect, the UE may report a capability of the UE to receive the multicast service using a plurality of transmission layers.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to receive from a communication network configuration information for measuring and reporting downlink channel characteristics, measure channel characteristics of a downlink beam from the communication network to generate channel measurements based on the configuration information, report the channel measurements to the communication network to enable the communication network to adapt the downlink beam as a multicast beam to provide multicast service to the UE and other UEs of a multicast group, and receive the multicast beam from the communication network to receive the multicast service.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A baseband processor of a wireless user equipment (UE) of a communication network comprising:
receiving from a base station of the communication network configuration information for measuring and reporting downlink channel characteristics;
measuring channel characteristics of a downlink beam from the base station to generate channel measurements based on the configuration information;
transmitting to the base station the channel measurements to enable the base station to adapt the downlink beam as a multicast beam to provide multicast service to the UE and at least one other UE of a multicast group; and
receiving from the base station the multicast beam to receive the multicast service.

2. The baseband processor of claim 1, wherein the configuration information comprises information for measuring the channel characteristics of the downlink beam based on reference signals transmitted using a reduced subset of a plurality of modulation and coding schemes (MCS) compared to MCS of reference signals used for measuring channel characteristics of a unicast downlink beam.

3. The baseband processor of claim 2, wherein measuring channel characteristics of the downlink beam comprises generating the channel measurements based on the reference signals transmitted using the reduced subset of the plurality of MCS.

4. The baseband processor of claim 2, wherein the reduced subset of the plurality of MCS has a larger step size in spectrum efficiency compared to a step size of spectrum efficiency associated with measuring channel characteristics of the unicast downlink beam.

5. The baseband processor of claim 2, wherein the configuration information further comprises a bit-mask used to select the reduced subset of the plurality of MCS associated with measuring the channel characteristics of the unicast downlink beam.

6. The baseband processor of claim 1, wherein the configuration information comprises a channel quality threshold, and wherein the channel measurements transmitted to the base station comprise an indication of whether the channel characteristics of the downlink beam measured by the UE meet the channel quality threshold.

7. The baseband processor of claim 1, wherein the configuration information comprises a current modulation and coding schemes (MCS) of the downlink beam, and wherein the channel measurements transmitted to the base station comprise an indication of whether the UE supports a preferred MCS selected as having one of higher, equal, or lower spectrum efficiency compared to the current MCS.

8. The baseband processor of claim 1, wherein the configuration information comprises information for measuring the channel characteristics of the downlink beam based on synchronization signals transmitted by the base station, wherein the synchronization signals are used by the UE to establish a connection to the communication network.

9. The baseband processor of claim 8, wherein measuring the channel characteristics of the downlink beam comprises generating the channel measurements based on the synchronization signals.

10. The baseband processor of claim 9, wherein transmitting the channel measurements comprises transmitting the channel measurements based on the synchronization signals when the UE establishes a connection to the base station.

11. The baseband processor of claim 9, wherein transmitting the channel measurements comprises transmitting the channel measurements based on the synchronization signals when the UE establishes a connection to a second base station of the communication network during a handover process or when the UE re-establishes a connection to the base station when transitioning from an inactive state to an active state.

12. (canceled)

13. The baseband processor of claim 1, wherein transmitting the channel measurements comprises transmitting a preferred multicast retransmission number preferred to be used by the base station to retransmit a previously transmitted multicast payload that fails to be received by the UE.

14. The baseband processor of claim 13, wherein measuring the channel characteristics of a downlink beam comprises measuring the channel characteristics of a plurality of candidate multicast downlink beams, and wherein the preferred multicast retransmission number is associated with each one of the plurality of candidate multicast downlink beams.

15. The baseband processor of claim 13, wherein the preferred multicast retransmission number indicates a preferred number of retransmission when the UE is in an inactive state.

16. The baseband processor of claim 1, wherein transmitting the channel measurements comprises transmitting a preference of the UE for receiving a multicast retransmission on a different frequency sub-band when the base station retransmits a multicast payload that was previously transmitted on a first sub-band.

17. The baseband processor of claim 16, wherein the preference of the UE for receiving a multicast retransmission on a different frequency sub-band comprises a preference of the UE for receiving the multicast retransmission using frequency-hopping.

18. The baseband processor of claim 1, wherein transmitting the channel measurements comprises transmitting a capability of the UE to receive the multicast service in a plurality of transmission layers.

19. The baseband processor of claim 18, wherein the plurality of transmission layers comprises a horizontal polarization and a vertical polarization of a 2-layer multicast downlink beam.

20. The baseband processor of claim 19, wherein the plurality of transmission layers comprises multiple-input-multiple-output (MIMO) layers for receiving by the UE multicast service and unicast service concurrently in time on one or more multicast beams and one or more unicast beams, where the MIMO layers comprise a maximum number of layers for receiving the multicast service on the one or more multicast beams or comprise a maximum number of layers for receiving the unicast service on the one or more unicast beams.

21. (canceled)

22. (canceled)

23. A base station of a communication network, comprising:
at least one antenna;
at least one radio, wherein the at least one radio is configured to communicate with a communication network using the at least one antenna; and
at least one processor coupled to the at least one radio, wherein the at least one processor is configured to perform operations comprising:
transmit to a plurality of wireless user equipment (UEs) of a multicast group configuration information used for measuring and reporting downlink channel characteristics;
transmit to the multicast group a downlink beam to enable the plurality of UEs to generate channel measurements based on the configuration information;
receive from at least one of the UEs of the multicast group the channel measurements; and
configure the downlink beam as a multicast beam to provide the multicast service to the multicast group based on the channel measurements.
